(19) United States
(12) Patent Application Publication
(10) Pub. No.: US 2012/0102013 A1
(43) Pub. Date: Apr. 26, 2012

(54) Method and Apparatus for Duration-Based Search

(76) Inventor: Christopher Martini, Berkeley, CA (US)

(21) Appl. No.: 13/082,200

(22) Filed: Apr. 7, 2011

Related U.S. Application Data
(60) Provisional application No. 61/322,765, filed on Apr. 9, 2010.

(51) Int. Cl. G06F 17/30

(52) U.S. Cl. 707/706; 707/E17.108

(57) ABSTRACT

Feasibility search considers the amount of time that one has to spend and combines it with a number of additional variables, such as location and personality information, historical search data, social networking, and check-in data, as well as real time transportation and event data, so a user can quickly find great things to do. The tool can also be used to determine if there is enough time available to complete a certain task. For example, “Do I have enough time to pick up a couple of things from Target before I pick the kids up from school?”

### CROSS REFERENCE TO RELATED APPLICATIONS

This application claims priority to U.S. provisional patent application Ser. No. 61/322,765, filed Apr. 9, 2010, which application is incorporated herein in its entirety by this reference thereto.

### BACKGROUND OF THE INVENTION

1. Technical Field

The invention relates to computer implemented information searching. More particularly, the invention relates to a method and apparatus for duration-based search.

2. Description of the Background Art

Life is hectic. There is much to do, little time to do it in, and it seems as though we are always on the go. With all of the tools available to help us find our way (GPS), to find information (Google), manage our schedule (Microsoft Outlook, Google Calendar), or interact with the world around us (FourSquare); there is no tool for finding the best way to use time or determine if there is enough time available to complete a given task. It would be advantageous to provide a tool that acts as a gauge, determines suitable options and allows for the best use of available time.

### SUMMARY OF THE INVENTION

A presently preferred embodiment of the invention provides feasibility search, which comprises a duration-based search technology. Feasibility search considers the amount of time that one has to spend and combines it with a number of additional variables, such as location and personality information, historical search data, social networking, and check-in data, as well as real time transportation and event data, so a user can quickly find great things to do. The tool can also be used to display the amount of free time available or determine if there is enough time available to complete a certain task. For example, “Do I have enough time to pick up a couple of things from Target before I pick the kids up from school?”

### BRIEF DESCRIPTION OF THE DRAWINGS

FIG. 1 is a block schematic diagram showing a feasibility search client software map according to the invention;

FIG. 2 is a view of a feasibility search Home screen according to the invention;

FIG. 3 is a view of a feasibility search stick shift slider according to the invention;

FIG. 4 is a view of a feasibility search Home, There state according to the invention;

FIG. 5 is a view of a feasibility search Home, nomeq state according to the invention;

FIG. 6 is a view of a feasibility search Home, Later state according to the invention;

FIG. 7 is a view of a Results Main screen according to the invention;

FIG. 8 is a view of a Map screen according to the invention;

FIG. 9 is a view of a Have Some Fun Results Main screen according to the invention;

FIG. 10 is a view of a Get Stuff Done Results screen according to the invention;

FIG. 11 is a view of a Get In Results screen according to the invention;

FIG. 12 is a view of a One Timer Results Main screen according to the invention;

FIG. 13 is a view of a mequalizer or ME-Q screen according to the invention;

FIG. 14 is a view of a mequalizer, Food Preset screen according to the invention;

FIG. 15 is a view of a mequalizer, Movie screen according to the invention;

FIG. 16 is a view of a The86List screen according to the invention;

FIG. 17 is a view of a To Do List screen according to the invention;

FIG. 18 is a view of a Tune Up screen according to the invention;

FIG. 19 is a view of a Feezi Bar component according to the invention;

FIG. 20 is block schematic diagram showing an end user usage scenario according to the invention;

FIG. 21 is a block schematic diagram showing an event partner location manager usage scenario according to the invention;

FIG. 22 is a block schematic diagram showing a hospitality event partner usage scenario for a restaurant or bar according to the invention;

FIGS. 23A-23C show a process flow for duration-based search according to the invention; and

FIG. 24 is a block schematic diagram of a machine in the exemplary form of a computer system within which a set of instructions for causing the machine to perform any one of the herein disclosed methodologies may be executed.

### DETAILED DESCRIPTION OF THE INVENTION

A presently preferred embodiment of the invention provides feasibility search, which comprises a duration-based search technology. Feasibility search considers the amount of time that one has to spend and combines it with a number of additional variables, such as location and personality information, historical search data, social networking, and check-in data, as well as real time transportation and event data, so a user can quickly find great things to do. The tool can also be used to determine if there is enough time available to complete a certain task. For example, “Do I have enough time to pick up a couple of things from Target before I pick the kids up?”

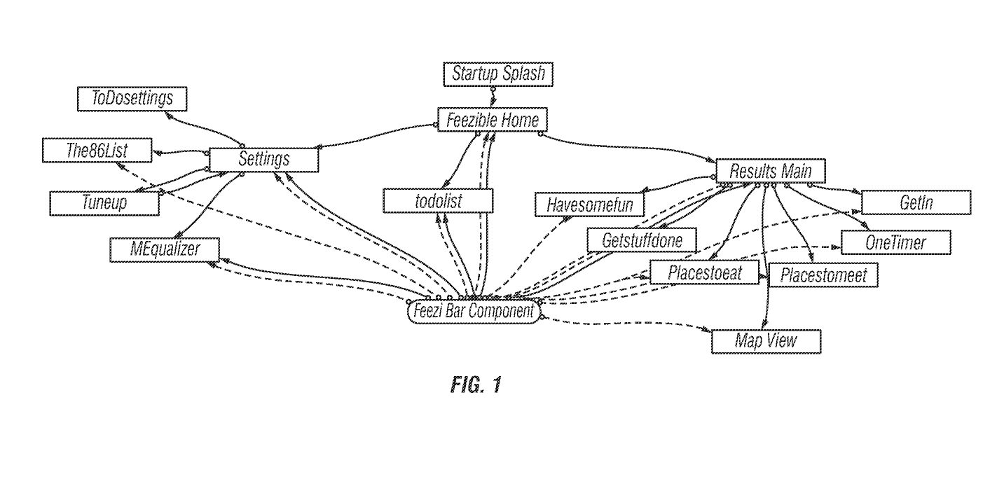

FIG. 1 is a feasibility search client software map. The feasibility search client software map shows the various navigation screens that make up the feasibility search client software (FCS). Some navigation screens, such as the Home screen, may have several visual states associated with them. For example, the home screen could be set to a number of different default views such as a count down timer of free time or ‘Things To Do Right Now’ based on user preferences. The Feezi Bar Component 11 that is present on multiple screens is shown with a dotted line to any screen on which the component is present. Each of the components shown in FIG. 1 is discussed below in connection with a corresponding figure.

Navigation Screens

Feasibility Search Home

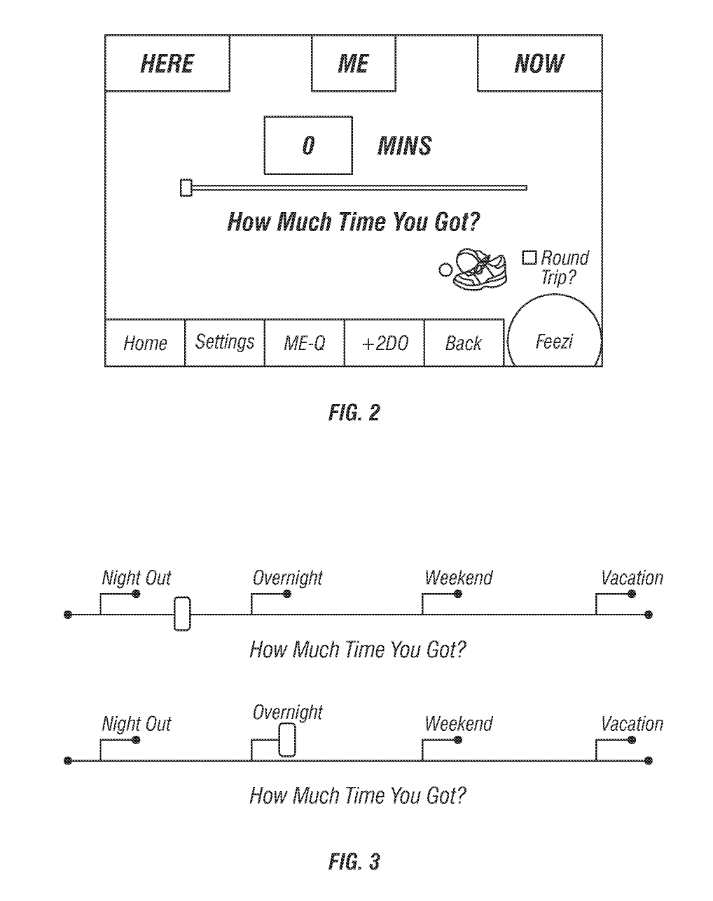

FIG. 2 is a view of a feasibility search Home screen. After the software loads, the end user is presented with the feasibility search Home screen. This is the primary interface screen and the screen from which feasibility searches are initiated. The user may also interact with the software using their voice when available and depending on the platform, for example, in a car or on a smartphone with voice recognition capabilities. A feasibility search represents a search for things that are capable of being done, based on the conditions a user wants the feasibility search facility to consider. The minimum input required from the user is to set the search duration via the ‘How Much Time You Got?’ slider 21. This assumes the user wants to search for something at the current location and at the current time. The user may also choose to include the current settings from the Mequalizer or ME-Q 25 (discussed below). The feasibility search stick shift slider, see FIG. 3, can also be set as the default input for setting the amount of time available. If the user has chosen to integrate the feasibility search software with their scheduling tool, this home screen can default to a countdown style view of free time, or suggestions based on amount of time, current location and user preferences.

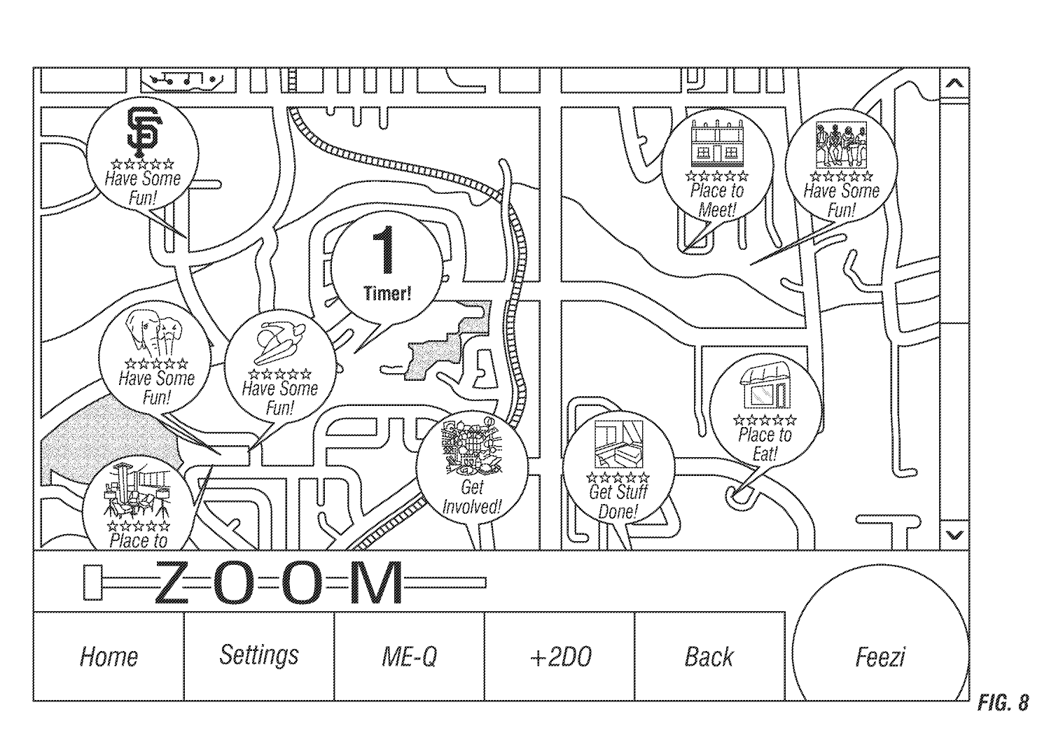

At this point, the user can also change a current mode of transportation and indicate if it is necessary to return to their current location or be at another within the allotted time by selecting the Round Trip button 22. Feasibility search may also check public transportation options if the user wishes. Once these selections are made, the user selects the Feezi button 23 and the search is started. Within a few seconds results are returned to the device and the user is presented with the Results Main screen (see FIG. 7).

FIG. 3 is a view of a feasibility search stick shift slider. The feasibility search stick shift slider makes it easy for a user to select a value that is outside of the ordinary range that the slider covers. For example, in FIG. 3, the slider for How Much Time You Got? has a minimum value of 10 minutes and a maximum value of a few hours. This range makes sense for an overwhelming number of searches when the user is looking for something to do locally. The different gear options on the slider offer values beyond this range, from an overnight trip to a vacation, without the user needing to go to a different screen to make this selection.

There State

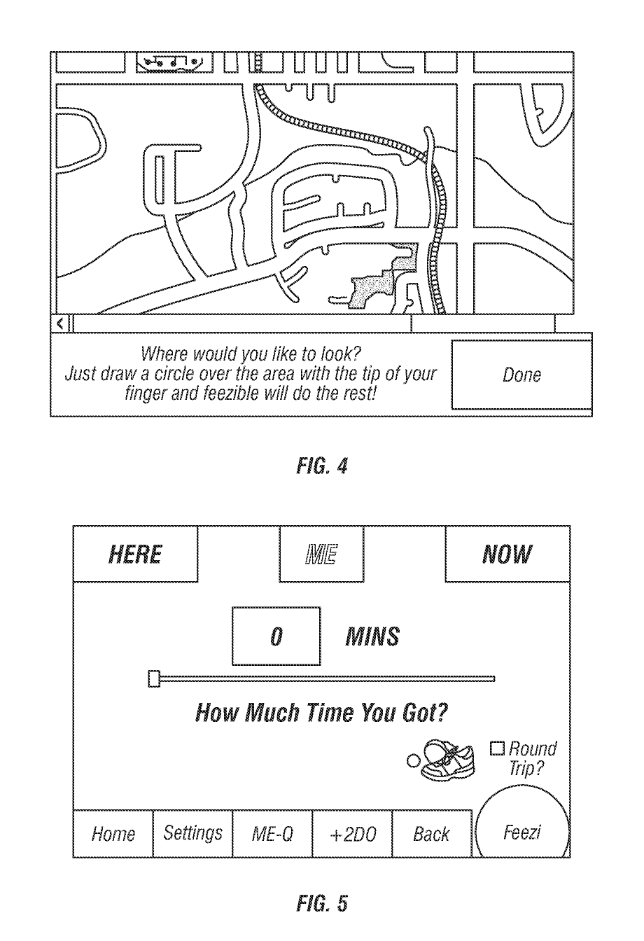

FIG. 4 is a view of a feasibility search Home, There State screen. If the user wishes to change the starting location for the search, they can select the HERE button 24 on the Home screen (see FIG. 2). This puts the Home screen into the THERE state, where a map loads allowing the user to change the start location. This is accomplished by the user moving the map to a general area and either touching, or drawing a circle around the start location. In both cases, the starting point is determined the same way. Either the circle or the outline of the fingertip is converted to a number of points along a perfect circle that covers approximately the same area. Several points along this circle are chosen and the center point of the circle is determined and set as the search starting point. This determination is accomplished in any of a number of ways. (For example, see the search starting point determination logic discussion below). It is also possible for a user to start the search from a location based on a set address, zip code, previous check-in locations, or presets.

NoMeQ State

FIG. 5 is a view of a feasibility search Home, NoMeQ state. If the user wishes to see all results with no filtering, other than the amount of time that they have, they may choose to temporarily disable the ME-Q settings. This is done by selecting the ME button at the top of the Home screen to invoke the No Me-Q state. If the No Me-Q state is invoked when the feasibility search is initiated, the feasibility client software does not include any ME-Q data with the search parameters.

Later State

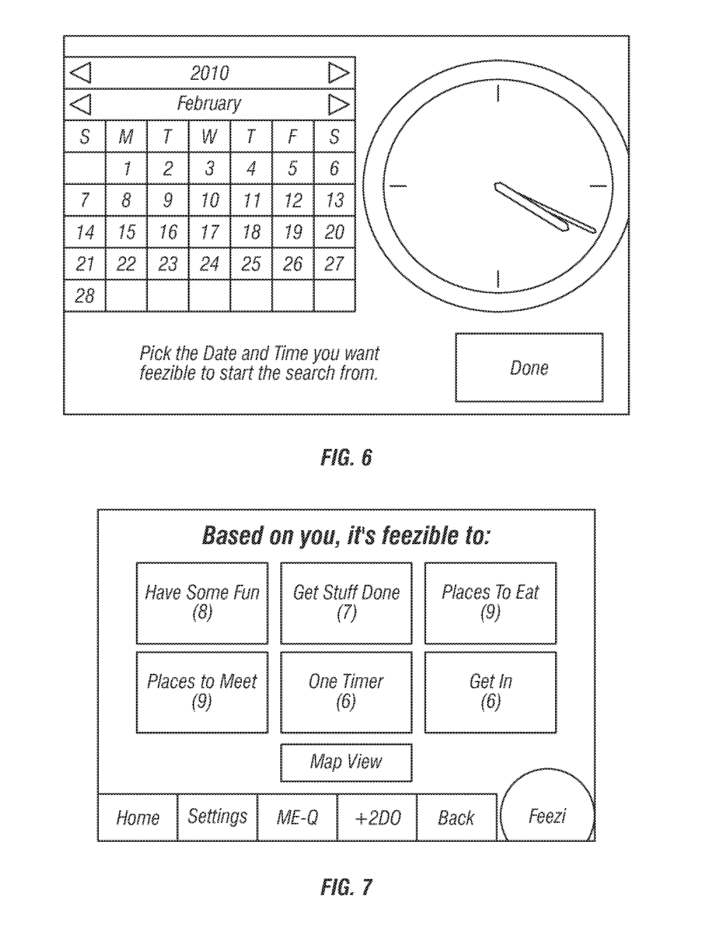

FIG. 6 is a view of a feasibility search Home, Later state. If the user wishes to change the date and/or time from which the feasibility search is started, they simply touch the NOW button 27 (see FIG. 2) on the Home screen to invoke the Later state of the Home Screen. The Later state presents the user with a clock 63 and calendar 62 interface that is quick and simple to use. When they have set the appropriate start date and time, they click Done 61 and return to the HOME screen.

Results Main

FIG. 7 is a view of a Results Main screen. The Results Main screen presents the user with a series of tiles or icons that represent the various categories that search results are broken down into, such as Have Some Fun 71, Get Stuff Done 72, Get In 73, Place To Eat 75, Place To Meet 76, and One Timer (places for a one time activity) 77. These categories change and are updated over time to reflect the most relevant results for each user based on their usage history. Touching a tile reveals the results in that category; the number of results in any activity is indicated numerically, as shown in FIG. 7, e.g. there are (8) place to Have Some Fun. In cases where the number of results categories is greater than the number of tiles on the Results Main screen, the user can swipe left or right to reveal additional tiles from off the sides of the screen. For each result returned, the user has the option in later screens of ‘Hyping’ an event that they are excited about. This may also be implemented using an already available API, such as the Facebook ‘Like’ button or Livenation Event Search Data. As more data becomes available about what is being hyped, this screen has a ‘See What The Hype Is’ button that lets a user see what is being hyped nearby. From this screen, the user can also choose the Map view button 74 to see the Map view in FIG. 8. The map view can also include a heat map of the local hype. For example, the icons may glow a different color based on a number of different data points.

Map View

FIG. 8 is a screen showing a Map view. The Map view screen shows all results from the Results Main screen represented by icons spread out over a map. Touching any of the icons brings up more details about the event. There are also buttons that correspond to the tiles on the Results Main screen that allow the user to sort which icons are shown on the map.

Have Some Fun Results Main

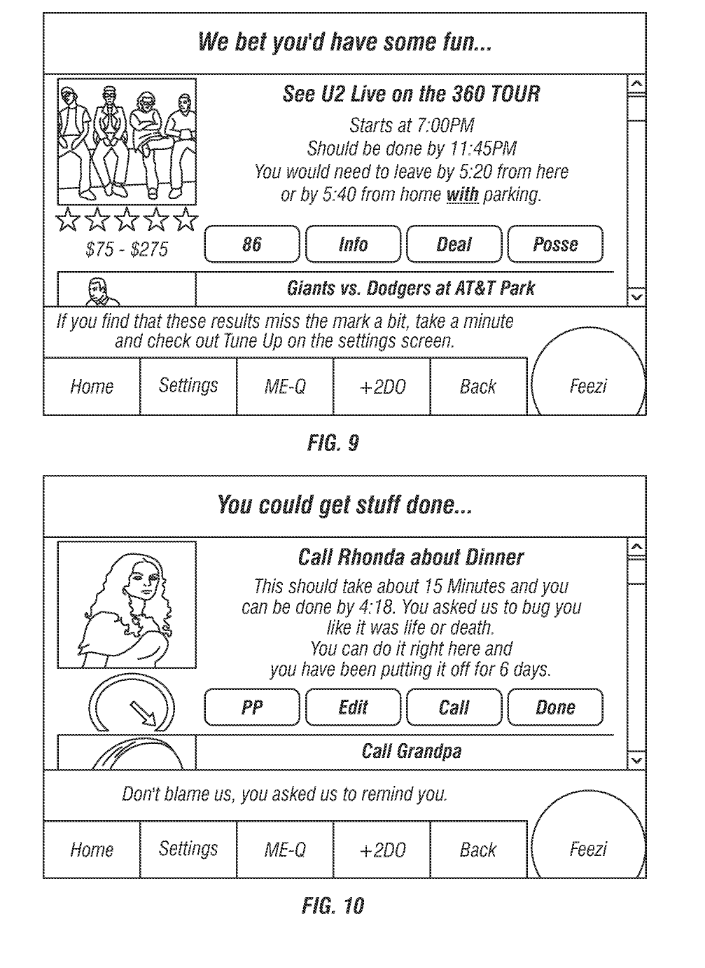

FIG. 9 is view of a Have Some Fun Results Main screen. The Have Some Fun Results main screen shows all results that were deemed possible by the feasibility search for this category, and sorted based on the feasibility search algorithm (discussed below). The event general information is displayed, including information such as the start time 91 and expected finish time 93, the time that one would need to leave by from a current location 92 and home location 94, and what type of parking is available 95. A representative thumbnail 96 is also displayed with ratings and price ranges or estimates below it. There are also a number of options available to the user at this point.

The 86 button 86 allows the user to add this event to their 86 list. Once something is added to the 86 list, it is not displayed in search results until it is removed from the 86 list within user settings 28 (see FIG. 2) on the FCS. The Info button 97 presents the user with more detail about the event, including how some of the information on the general information screen was calculated, such as price and finish time.

The Deal button 98 lets the user quickly see if there are any deals available and what they are. Selecting this button also adds one to the value of the Deal Query for this event.

The Posse button 99 allows the user to connect to contacts in a number of ways, including social networking such as Facebook and Twitter, or via SMS or e-mail, to get a group to go to the suggested event. When a message is sent from the posse section, it carries with it details about the event or a link to more information about the event.

Feasibility search also adds a ‘Hype It’ button to results (not shown). This gives end users a quick and easy way to indicate an interest in an event that they are excited about. In addition, in some embodiments Hype It data is available to premium partners so that they can look for hot events to co-market. Some embodiments of the invention combine the “Deals” and “Hype It” buttons into one because they are both used to express interest in an event.

Get Stuff Done Results

FIG. 10 is view of a Get Stuff Done Results screen. The Get Stuff Done Results screen shows the user any item from their feasibility search To Do list that can be accomplished within the given parameters of the search. Each item from the To Do list that meets the duration feasibility test is shown in a sorted list. The list is sorted based on a number of variables, such as the initial importance selected when the item was entered on the to do list, number of times or number of days it has been postponed, distance from where the user needs to be to complete the task, current search settings and how easily it can fit into the user's schedule.

Get In Results

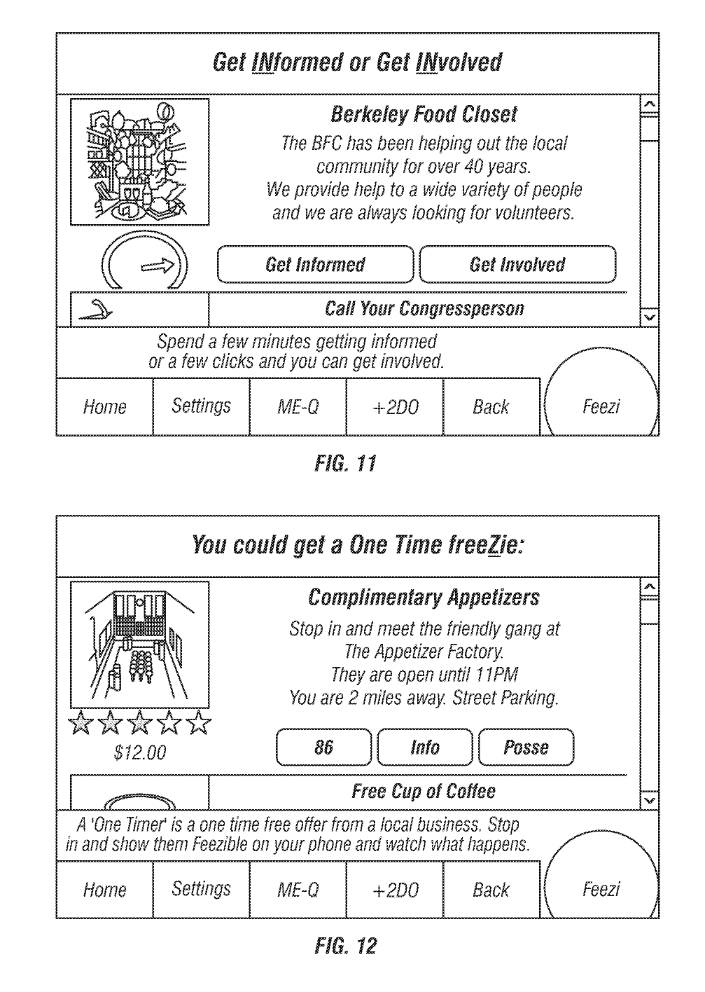

FIG. 11 is view of a Get In Results screen. The ‘Get In’ Results screen offers a user the ability to spend some time getting informed or getting involved in a range of issues. Local charities, national and international causes, and political and anthropological topics, for example, are identified and coupled with a thumbnail image, brief overview, and a gauge that indicates the likelihood that the issue is of importance to the user. The gauge value 111, as well as other personalization within the feasibility search, is determined by the settings and tune up pages, in addition to any other information that the user chooses to share, such as browsing history, current location, location history, social networking information, crowd sourced data, etc.

The end user can scroll through the results and, when they would like to act, choose Get Informed 112 or Get Involved 113. The Get Informed button brings up a deeper dive into the issues that relate to the topic. The Get Involved button brings up a variety of ways the user can take actions related to the topic. For example, in the case of a charity, the Get Informed option gives the user information of the history of the organization, the key demographics and/or geographies served, and any other key data points. The Get Involved button gives the user the option to do things such as make a donation, sign petitions, call government representatives, view volunteer opportunities, or write letters for a cause.

One Timer Results Main

FIG. 12 is a view of a One Timer Results Main screen (see FIG. 7, One Timer button 77). The One Timer Results Main screen presents the user with a number of options that they can only receive one time. The number and quality of these offers can be based on a number of different variables from user rating, to distance from home, or number of other offers, Hype It stats, etc. For example, a restaurant may want to make a special offer to locals, while a concert venue may want to inspire someone to drive to it.

MEqualizer

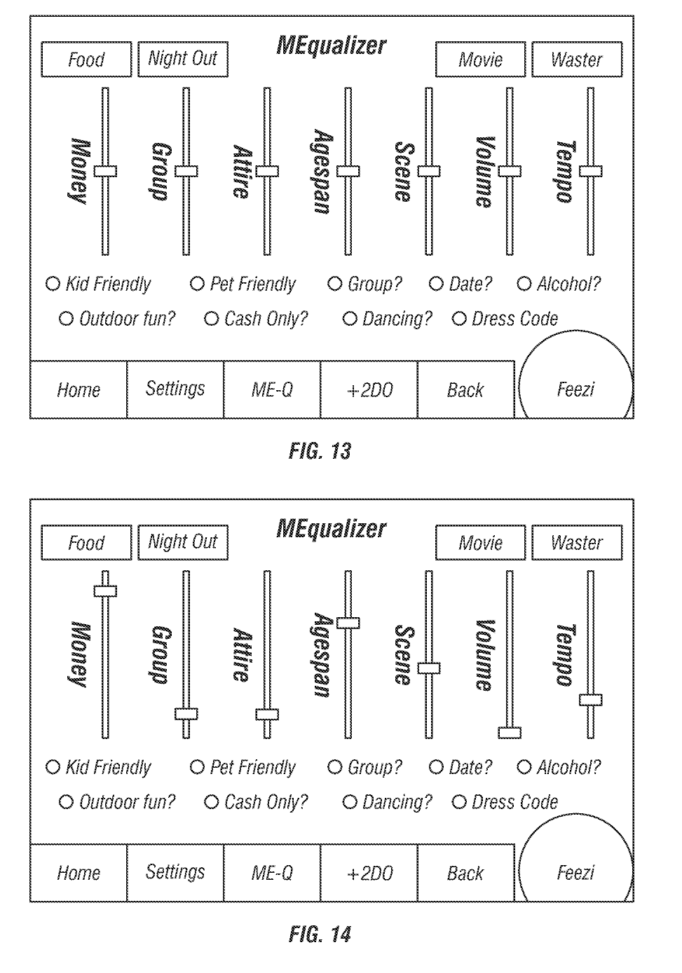

FIG. 13 is a view of a MEqualizer or ME-Q screen. The MEqualizer, or ME-Q is an intuitive interface for quickly changing the parameters of feasibility searches. The ME-Q makes the input of complicated search parameters second nature. Variable attributes, such as the amount of money the user is willing to spend 131, the number and make up of the user's party 132, or the vibe and energy of the time the user is looking for 133 are set via a collection of vertical or horizontal sliders. Yes and No indicators, such as whether or not you want a location that sells alcohol 134 or is a cash only venue 135 are set via a radio button. On an audio equalizer, there are presets for different types of music listened to regularly. With the feasibility search ME-Q, the user can have presets for the types of things that he does regularly, from grabbing a quick bite to eat 136 to a night out 137, or even something as simple as catching a movie 138 or wasting some time wherever you are 139. The user can set up presets that are right for him in the settings, and make searching easier and quicker.

Food

FIG. 14 is a view of a Mequalizer showing the setting of the sliders for a Food Preset example. FIG. 14 shows what one possible effect of selecting a preset is on the overall ME-Q settings. By selecting one button (see FIG. 13, the Food button 136), the user can quickly adjust many settings simultaneously for things that they search for regularly, such as a place to eat. A user sets up a

Food preset, or perhaps a different preset for dine-in or delivery options and find exactly what he likes, without having to waste time filtering and sorting through results that a software tool can take care of.

Movie

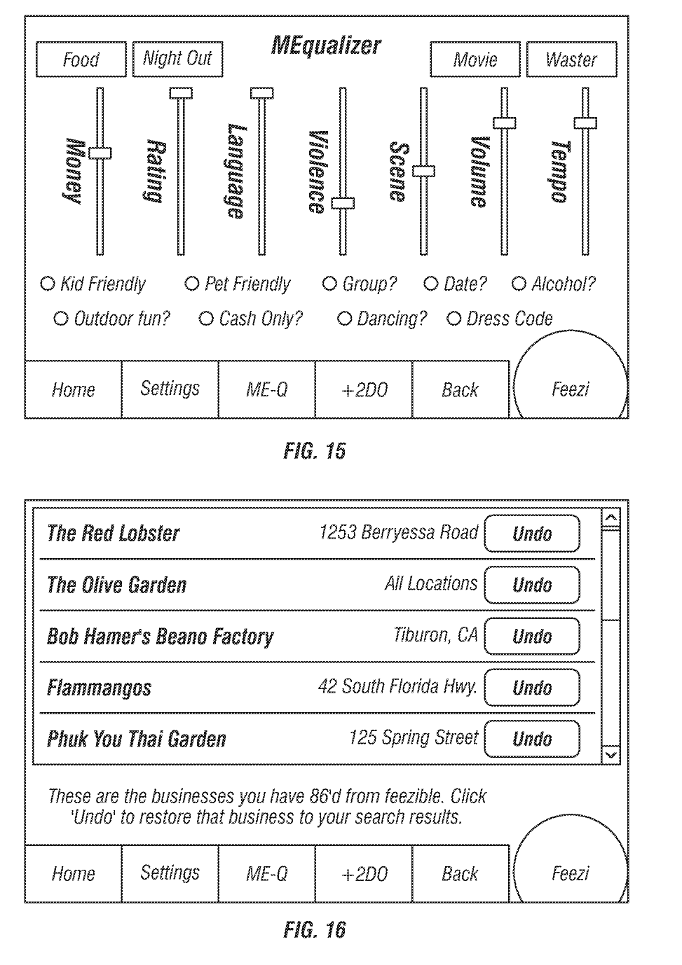

FIG. 15 is a view of a Mequalizer showing the setting of the sliders for a Movie. In some cases, the standard selection of buttons and sliders in the ME-Q might not be relevant. In the case of a movie, a user is much more concerned about the genre or subject matter of a movie and is already familiar with how to dress for the occasion. In situations such as this, the ME-Q adapts quickly to the given search situation by swapping out the standard sliders and radio buttons for selections that are more relevant. An end user may also set up custom presets for certain types of searches on their own.

Similarly, if the end user selects the ‘Wasters’ preset in the ME-Q, the settings change to give the user control over the ways he likes to waste some time. The user can pick from a number of content partners, in addition to selecting buttons and sliders that help find local, quick, and free ways to spend an idle few minutes. Feasibility search help one find just the right thing, e.g. the record shop that is around the corner in a city the user is unfamiliar with, or the farmer's market in the user's home town that he had forgotten about.

Settings

The86List

FIG. 16 is a view of The86List screen. The ‘86 List’ is a list of events, advertisers, restaurants and bars, locations, and franchises that the end user has decided they do not want to do business with.

On any results or information screen, the user only needs to touch the ‘86’ button and that result is removed from the list. For example, if a user tries a restaurant a couple of times and decide it just isn't for him, he can make it so it is no longer necessary to worry about it. Of course, at any time the user can go to the ‘86’ list under settings and make changes. In some cases, the user is presented with a prompt asking if he want to remove just that location, or an entire franchise. This anonymous data can be packaged and is visible in a number of different views to feasibility search customers and partners. For example, a franchise such as McDonalds is visible in the search results at no cost to McDonalds. However, to access data, e.g. which locations in their franchise are most often 86′d, McDonalds would need to be a premium partner.

To Do List

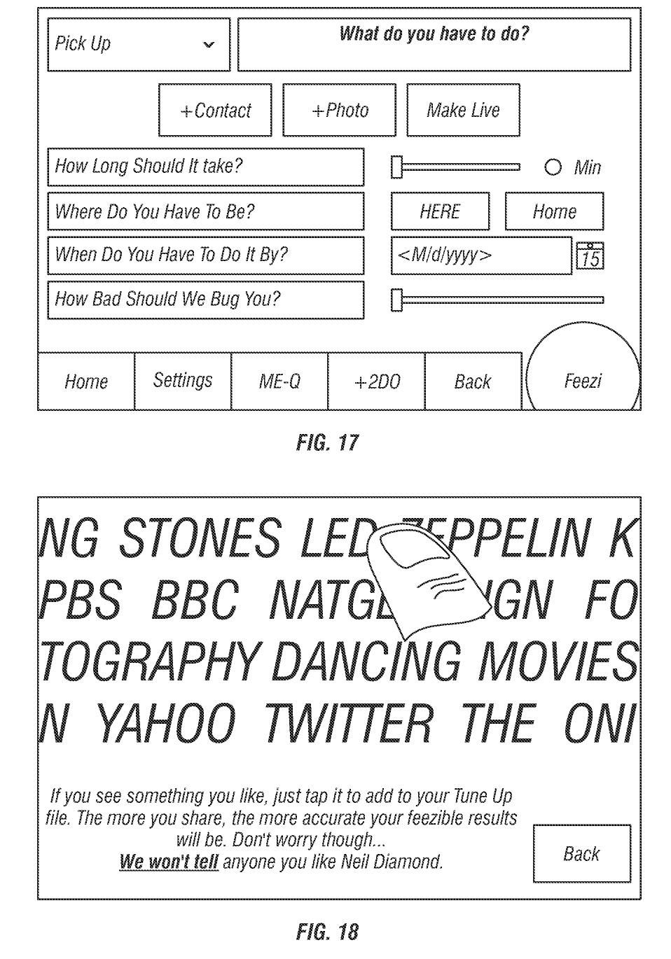

FIG. 17 is a view of a To Do list. A feasibility search recognizes that sometimes when a person is looking for something to do he wouldn't mind getting something done as well. To make one as productive as possible, feasibility search gives a user the option of using the integrated To Do list and incorporating those items into the search results.

At the top of the To Do entry screen, the user selects a prefix from the drop down list 171, such as Pick Up, Drop Off, Buy, Call, Research, etc. This is combined with a few words entered by the user 172 about the activity to create the complete ‘To Do Title.’ The user has the chance to tie this item to a contact 173 or relevant photo 174. In some cases, the user may wish to select ‘Make Live’ 175. For some to do items, where research and information gathering is involved, there is an opportunity for technology to do some of the digging so that the user doesn't need to. To this end, ‘Make Live’ carries out some parts of the to do without interaction from the user. For example, if the To Do title is “Research Wide Screen TV's” or “Buy Digital Camera” and Make Live is selected, a feasibility search finds a few key websites, and links and delivers them wherever the user wishes, such as via phone or e-mail. Moments later, the user receives an alert that provides the best reviews, best prices, and closest locations where the product is available. ‘Make Live’ can also be set up to ‘alert’ the user when they are within a certain range or distance of a To Do item. Next, the user adds information, such as how long the activity should take 176, and where 177 and by when 178 it needs to be completed.

Finally, the user adjusts the ‘How Bad Should We Bug You?’ slider 179 which does two things: First, it sets a value flag in the background that can be used for weighting search results. Second, it can cause certain types of alerts to be triggered, such as a text message a week before a birthday gift needs to be purchased, or an alarm if the user gets within a certain range of being able to complete a task.

Tune Up

FIG. 18 is a view of a Tune Up screen. The Tune Up screen under Settings 28 (see FIG. 2) is the innovative way that feasibility search gets to know a user's likes and dislikes, in addition to the traditional ways such as scanning music collections, browsing histories, or social networking information. The Tune Up screen is a collection of scrolling words that are culled from various locations, such as the description fields in a feasibility search activities database, twitter trends, event lists and descriptions or various third party API's. These word collections change from time to time when software updates are made available, or when a user wants to fine tune the results that they are getting through feasibility search. In addition to information from the FAD, feasibility search mixes in funny questions or current events information. This inspires users to tune up every so often, which provides better results. The answers to these questions can be shown as poll results as a time waster. As the words scroll by in all directions, the user simply reaches out and touches 181 the words that they like.

This turns the word status to ‘on’ in their Tune Up file and, in only a few seconds, there is a usable, reliable, and anonymous user profile that can be used to promote or eliminate search result items.

Component Screens

Feezi Bar Component

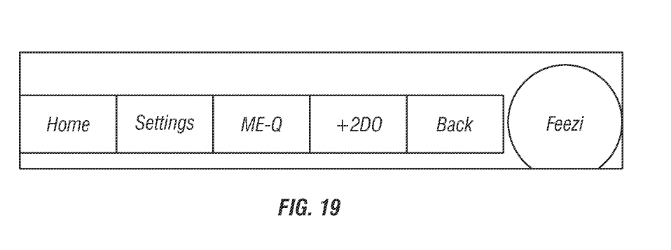

FIG. 19 is a view of a FeeziBar component. The FeeziBar is the main navigation bar that is usually located at the bottom of the feasibility search user interface. The Feezi button on the right is replaced with the Feasibility search button logo icon.

Usage Scenario Diagrams

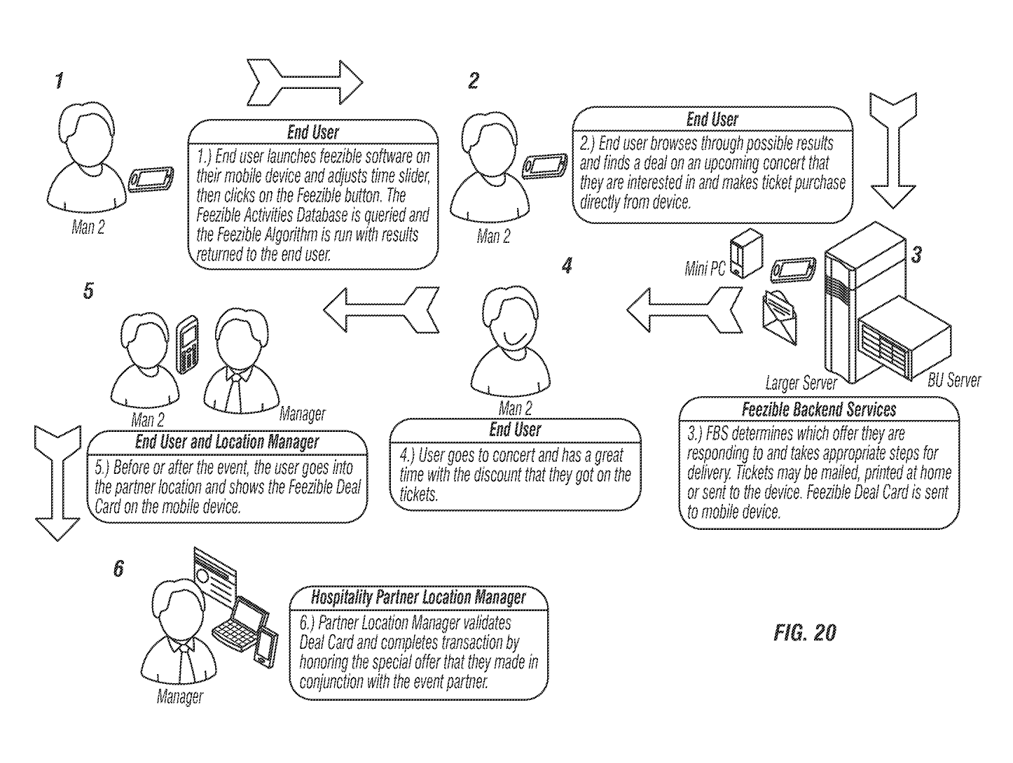

FIG. 20 is a block schematic diagram showing an end user usage scenario, in which:
The end user launches feasibility search software on their mobile device and adjusts the time slider, then clicks on the feasibility search button. The feasibility search activities database is queried and the feasibility search algorithm is run with results returned to the end user (201).
The end User browses through the results and finds a deal on an upcoming concert that they are interested in and makes ticket purchase directly from device (202).
The FBS determines which offer the user is responding to and takes appropriate steps for delivery. Tickets may be mailed, printed at home, or sent to the device. A feasibility search Deal Card is sent to mobile device (203).
The user goes to the concert and has a great time. The user applies the discount that he got on the tickets (204).
Before or after the event, the user goes into the partner location and shows the partner the feasibility search Deal Card on the mobile device (205).
The partner location manager validates the Deal Card and completes the transaction by honoring the special offer that they made in conjunction with the event partner (206).

For all of those who offer feasibility search as a partner, from corporate sponsors to local small business owners, feasibility search is a tremendously powerful tool for data mining and revenue growth. The feasibility search partner dashboard helps partners see valuable real time data about events and locations that are hot in their area, and provides a simple interface for connecting and delivering co-marketing offers in ways that would have been nearly impossible before.

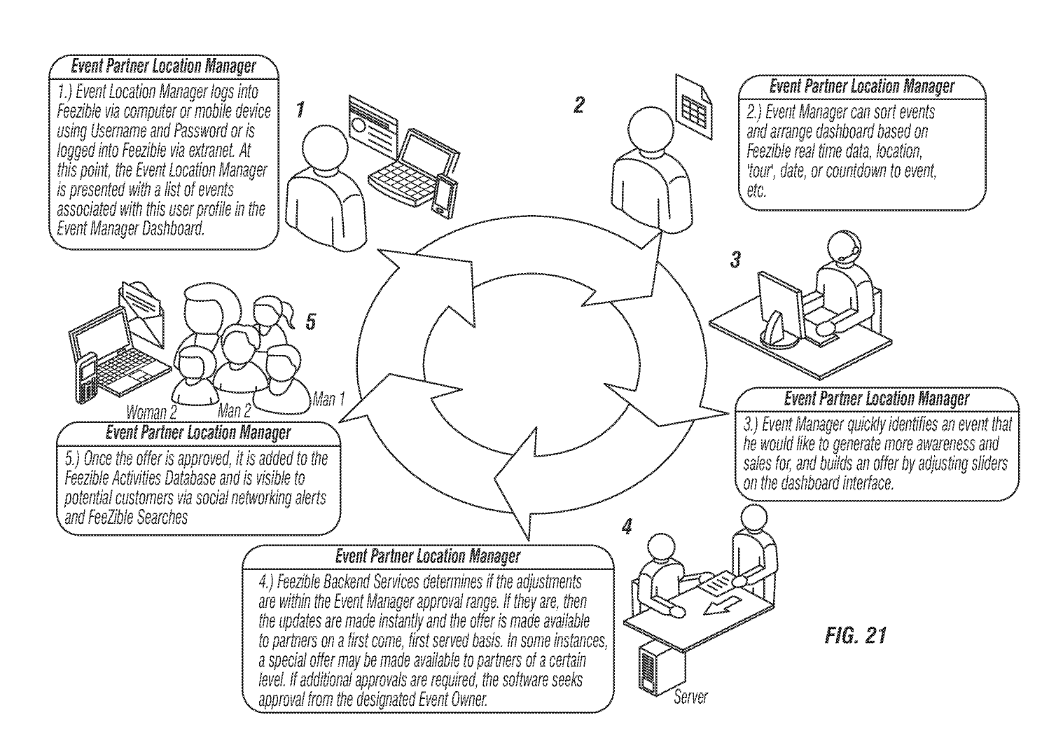

FIG. 21 is a block schematic diagram showing an event partner location manager usage scenario, in which:
The event location manager logs into feasibility search via a computer or mobile device using a Username and Password, or is logged into the feasibility search via an extranet. At this point, the event location manager is presented with a list of events associated with this user profile in the event manager dashboard (211).
The event manager can sort events and arrange dashboard based on feasibility search real time data, location, tour, date, or countdown to event, etc (212).
The event manager quickly identifies an event that he would like to generate more awareness and sales for, and builds an offer by adjusting sliders on the dashboard interface (213).
Feasibility search backend services determine if the adjustments are within the event manager approval range. If they are, then the updates are made instantly and the offer is made available to partners on a first come, first served basis. In some instances, a special offer may be made available to partners of a certain level. If they are not, then the software seeks approval from the designated event owner (214).
Once the offer is approved, FBS updates the FAD. In addition, any user who requested an update when an offer is made available gets updated via their preferred method (SMS, Twitter, Facebook). In the meantime, the event manager decides which event to work on next (215).

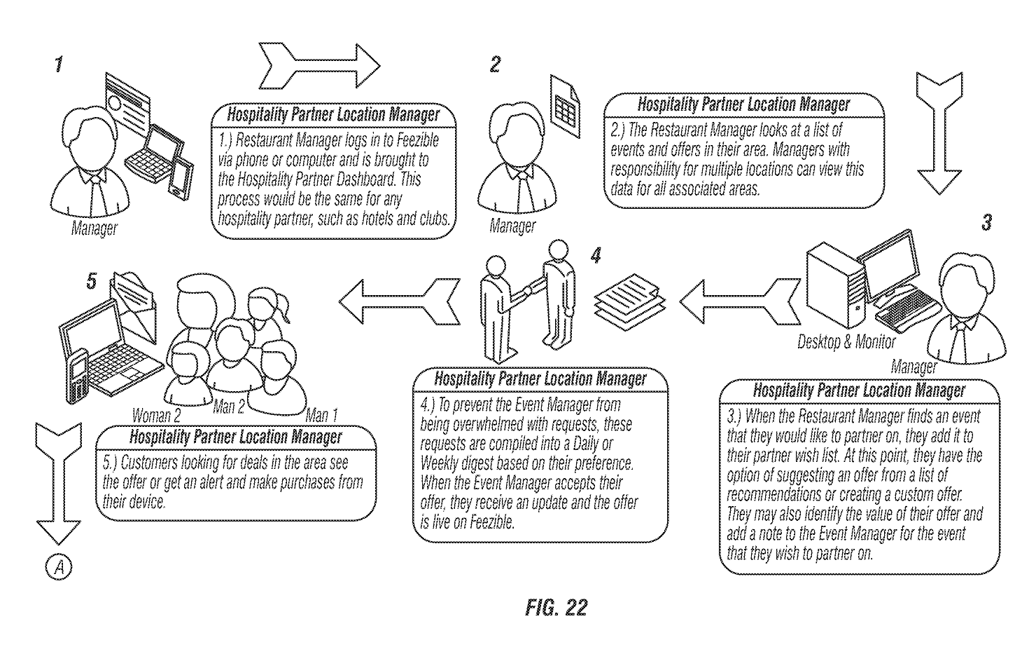

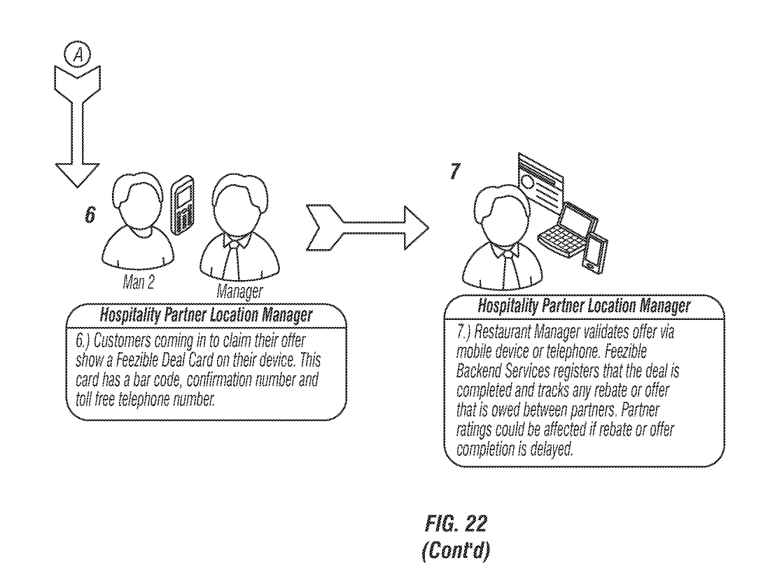

FIG. 22 is a block schematic diagram showing a hospitality event partner usage scenario for a restaurant or bar, in which:
A restaurant manager logs in to feasibility search via phone or computer and is brought to the hospitality partner dashboard. This process is the same for any hospitality partner, such as hotels and clubs (221).
The restaurant manager looks at a list of events and offers in their area. Managers with responsibility for multiple locations can view this data for all associated areas (222).
When the restaurant manager finds an event that he would like to partner on, it is added to the partner wish list. At this point, the restaurant manager has the option of suggesting an offer from a list of recommendations or creating a custom offer. He may also identify the value of the offer and add a note to the event manager for the event that he wishes to partner on (223).
To prevent the event manager from being overwhelmed with requests, these requests are compiled into a daily or weekly digest based on the event manager's preferences. When the event manager accepts an offer, he receives an update and the offer is live on feasibility search (224).
Customers looking for deals in the area see the offer or get an alert and make purchases from their device (225).
Customers coming in to claim their offer show a feasibility search Deal Card on their device. This card has a bar code, confirmation number, and toll free telephone number (226).
The restaurant manager validates offer via mobile device or telephone. Feasibility search backend services registers that the deal is completed and tracks any rebate or offer that is owed between partners. Partner ratings could be affected if rebate or offer completion is delayed (227).

Feasibility search Search Algorithm Overview

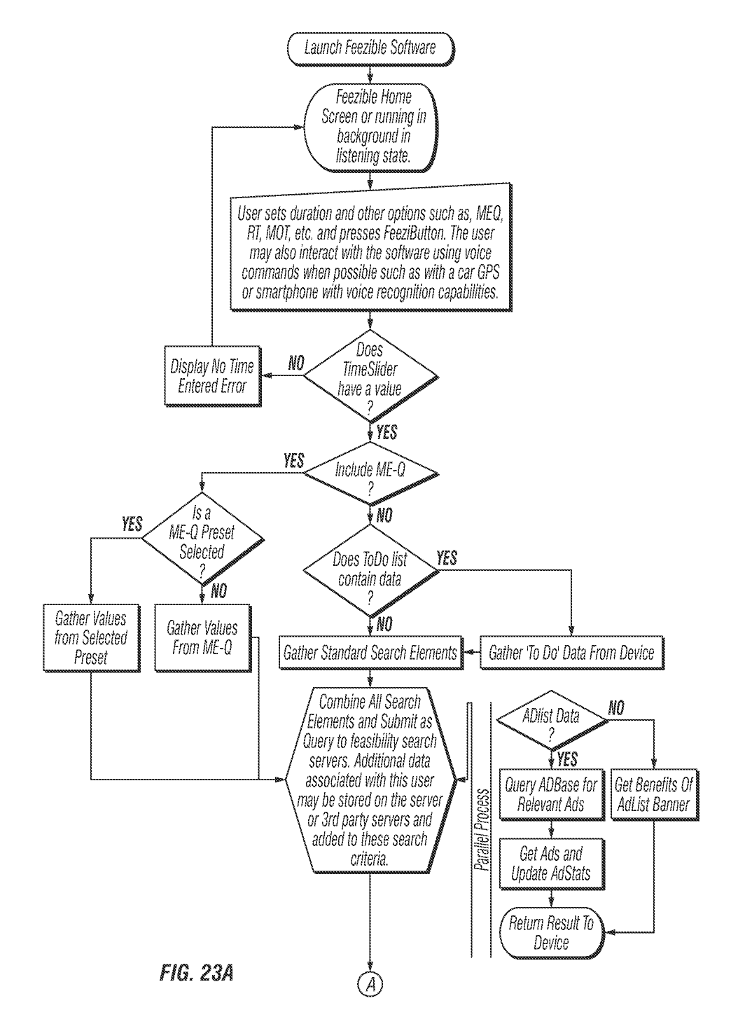

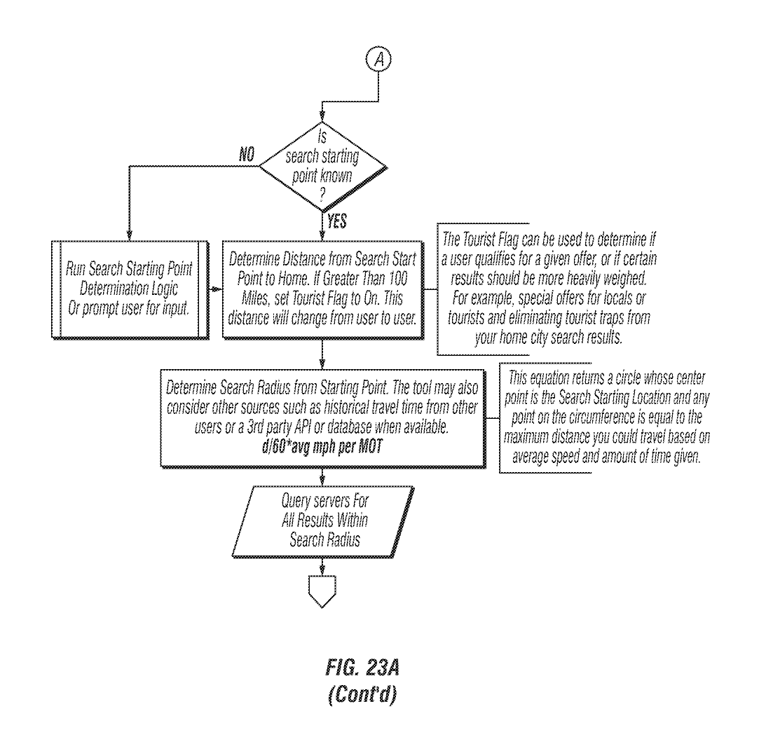

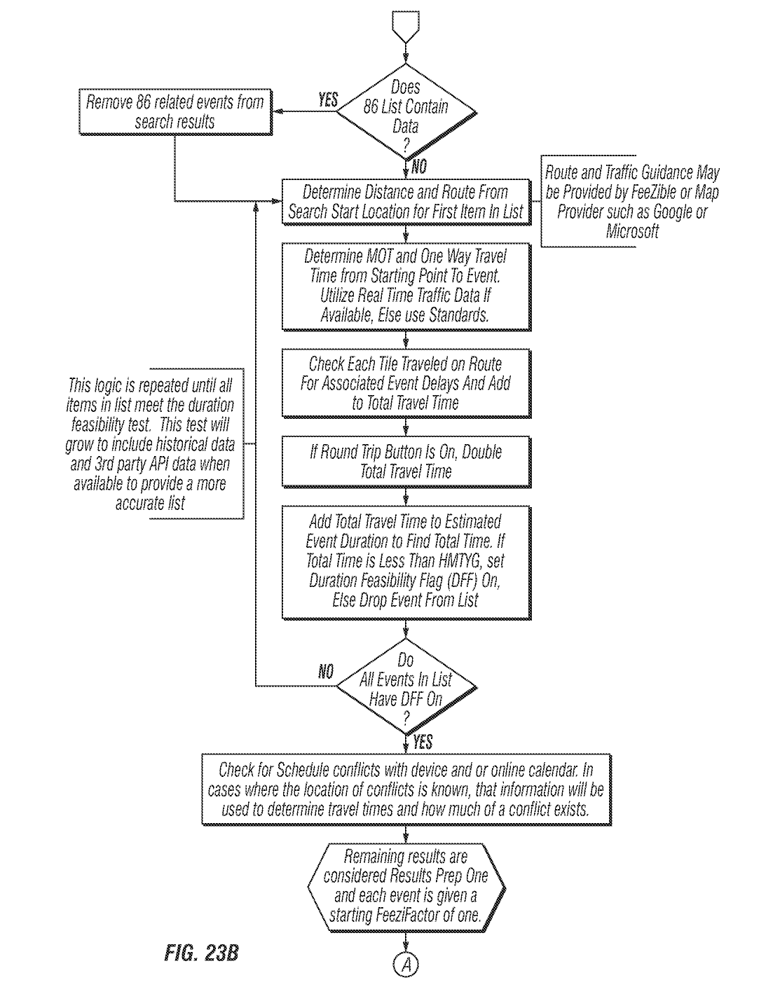

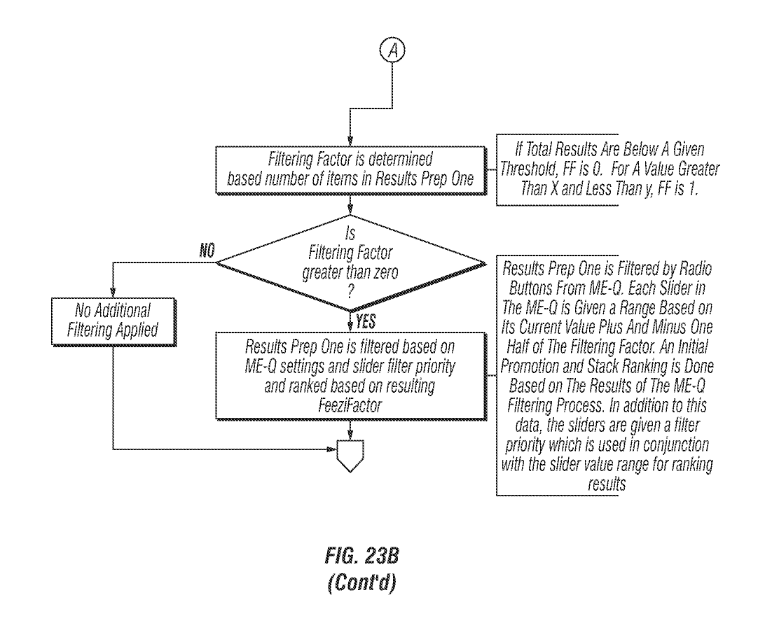

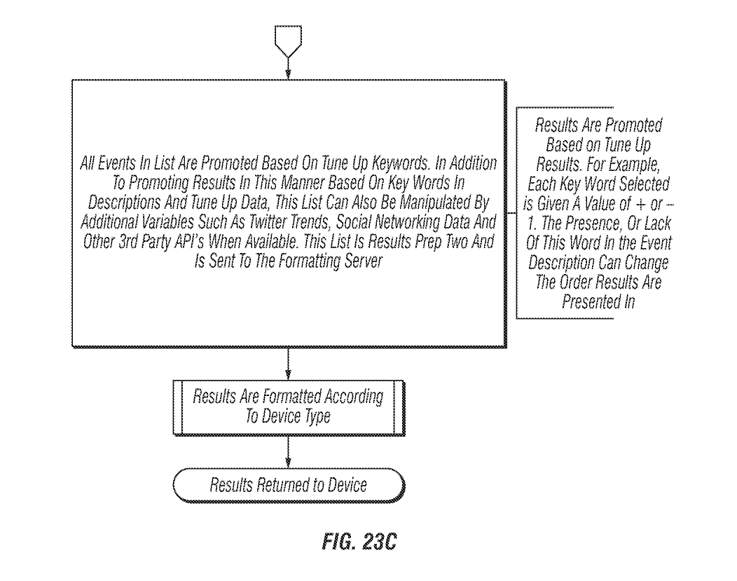

FIGS. 23A-23C show a process flow for duration-based search according to the invention. A feasibility search is started by the user adjusting the “How Much Time You Got?” slider and pressing the ‘feezi’-button on the home screen (230). The software can run on a mobile device, such as a tablet, phone, or laptop, a desktop computer, or be part of a car GPS and navigation solution. The end user may also choose to interact with the software using their voice when possible, such as in a car with integrated voice and GPS or on a smartphone with voice recognition technology built in. The feasibility client software (FCS) then determines which information needs to be gathered and submitted to the feasibility search activities database (FAD) (231). FCS determines if ME-Q data should be included (232), if the round trip button is selected, and mode of transportation. This information is then added to standard search elements and sent to feasibility search. Standard search elements are defined as search start location, distance from home, start time, duration, settings, username, 86 list, ADList, and device type (233). Some of this data may be stored on the server and accessed based on login credentials. In addition, log in details can be provided by a third party login via Facebook® or another third party API. Once these steps are complete, the appropriate information is put into query form and the FAD is queried (234).

Does the user's ADlist have any entries (235)? If so, the advertiser database is searched and if a relevant ad is found, it is sent to the device and run while results are generated. The ‘AdRep’ of the username associated with the search increases by one. At some point, the AdRep number may be used to earn rewards such as discounts or invitations to VIP events (236).

The first step performed in the query is determining the search area. Is starting point known (237)? If no, then the search starting point algorithm is run (238). If yes, then search area radius is calculated by duration (D) divided by 60, multiplied by the average mph per mode of transportation (239). This returns a circle whose center point is the search start location and any point on the circumference is equal to the maximum distance you could travel with the average speed and amount of time given (240). The tool may also check historical travel time from other users or a third party API or database, when available. If Event Awareness is selected in User Settings, then the area is scanned for any event that is marked as a potential deterrent and the search results are scrubbed against this. If a conflict is found, a quick result is returned to the device to alert the user. For example, the user could be reminded that a restaurant of interest is along a parade route or near the stadium on game day. This message stays on the screen until the user accepts it and the results are returned (241).

At this point, all possible search results are returned to the results preparation queue and any To Do List items associated with the username are added to the list of possible results (241). At this point, all possible results are considered events and treated the same.

The 86 list associated with the user is then checked for contents (242). If the 86 list has entries, then the possible results list is scanned for matches on the 86 list and these are removed. This saves the user the work of having to go through recommendations that they have already indicated no interest in. At this point, the software also checks to see if the ‘Tourist Trapper’ check box is selected in User Settings (243). If it is, then adjustments to the search results may be made in a number of ways. For example, when a user initiates a search within an hour of home, tourist related activities, events and restaurants may be removed from the search results. Conversely, if the user is more than a specified distance away from home, these types of events may be promoted by having a variable added to their FeeziFactor.

Initial duration based feasibility test is done on all remaining results and all failed results are removed.

An embodiment of the duration-based feasibility test is (244):

Calculate distance of event from search start location. Divide distance by rate of speed to determine one way travel time. Feasibility search also ties into real-time traffic updates and adjusts travel time as appropriate. The software can also connect to third party traffic or travel time API's for historical route travel times, if available. If the RT button is pressed, multiply travel time by two. This represents total expected travel time. The total expected travel time is then added to the expected event duration. If the ‘Add Event Buffers’ radio button is selected in User Settings, then any appropriate event buffers, such as average wait time, average parking time, and others are added to provide a more accurate estimate of the time required to do something. All of these variables are added together to determine the Total Time For Event. If total time is greater than the amount of time available, as entered by the user via the How Much Time You Got Slider or voice commands, the event is removed from results list. At this point if the ‘Check for Schedule Conflicts’ button is selected in User Settings, feasibility search can check the user's current local and online calendar to determine any schedule conflicts (245). In cases where the precise physical location of the conflicting item is known, this information is used to determine a more precise estimate of how much of a conflict exists.

The resulting list represents Results Prep One and each event on the list is given a starting ‘FeeziFactor’ of one (246).

Total number of events in Results Prep One is used as basis for results pool quality filtering factor (247). For example, if the total number of events listed in results prep one is less than 25 then a filtering factor of 0 is established. If the total is 26-75, then a filtering factor of 4 is applied and so on.

If the filtering factor is greater than 0 (248), then additional results filtering is applied.

Results Prep One is filtered based on radio button values from the ME-Q (249). Because radio buttons are binary (only on or off), results that do not meet the search criteria are easily removed. A ME-Q slider value range is established for each slider in the ME-Q based on the value of that slider plus and minus one half of the filtering factor. For example, if the slider has a range of ten, and a value of six with a filtering factor four, then the slider range is four to eight. Each slider is also given a filter priority which is used in conjunction with the slider value range during promotion and stack ranking of results. For example, price may be a more important factor than dress code. The end user can control the filter priority based on, for example, the left to right order of sliders in the ME-Q. Results Prep One list is then filtered based on a combination of all relevant slider ranges from the ME-Q. An initial promotion and stack ranking of events is done based on the relevance of the ME-Q filtering process. Any instance where the slider value submitted is equal to the slider value given in the FAD, the ‘FeeziFactor’ is increased by five. If the slider value selected in the FAD is within the slider range, then the FF is increased by two. If the slider range does not fit the event as listed in the FAD, then the FF is unchanged. If no parity is found between any slider ranges and slider values from the FAD, the FF is decreased by two.

Once this step is complete, or if the Filtering Factor is 0, the results are promoted based on key words from the feasibility search Tune Up (250). For example, each keyword that is selected in the Feasibility search tune up is given a weight of either + or −1. Each event description in Results Prep One is searched for the presence of any keyword from the Tune Up list. Any word that is present and selected increases the ‘FeeziFactor’ by one. Similarly, any word that is present in the description and not selected decreases the ‘FeeziFactor’ by one. In addition to tune up keywords and even descriptions, this process can incorporate social networking data, search history, twitter trends or other third party API data. The resulting list represents Results Prep Two.

Results Prep Two is then sent to the formatting server (251). The device type is used as a basis for formatting search results to fit the screen of the device that the search was initiated from. This accounts for differences in screen size and resolution that are prevalent in the mobility space.

Once the results are formatted, results are returned to the device (252).

Search Starting Point Determination Logic

In instances where the user has changed the search starting point to something other than the device current location, the search starting point determination logic is run. The user can draw a circle on the map with their finger or touch the map in the area where the search should begin. In both cases, the starting point is determined in the same manner. First, the software only allows for the drawing of a perfect circle. The center point of the circle is determined using a calculation based on the location of several points on the circles circumference as follows or provided directly to the software from the device where possible:

Let (F,Z) be the coordinates of the center of the circle, and r its radius. Then the equation of the circle is:

(F−h)̂2+(Z−k)̂2=r̂2 (1)

Because the points all lie on the circle, their coordinates will satisfy this equation. That gives you several corresponding equations:

(F1−h)̂2+(Z1−k)̂2=r̂2 (2)

(F2−h)̂2+(Z2−k)̂2=r̂2 (3)

(F3−h)̂2+(Z3−k)̂2=r̂2 (4)

To solve these, subtract the first (2) from the other two (3), (4). That eliminates r, hA2, and kA2 from the last two equations, leaving two simultaneous linear equations in the two unknowns h and k. Solve these, and we have the coordinates (h,k) of the center of the circle.

Finally, set:

r=sqrt[(F1−h)̂2+(Z1−k)̂2] (5)

Combining this coordinate with data from a third party map service, or an internal service, provides the feasibility search activities database with the search starting point.

Additional Embodiments

An embodiment of the feasibility search home screen has a ‘Big Deal’ button that has a special offer based on location, user status, luck, or date and time. The user can click the button anytime to see what the big deal is. In an embodiment there is no button per se. Rather, the user applies a combination of settings or nudging the Feezibutton in a number of directions to input a code. For example, touching the Feezibutton and pushing it up, up, left, up, left, down unlocks an incredible deal. Similar to a secret code in a video game that unlocks content. The big deal could be either a truly incredible deal, or a ‘Lifestyles of the Rich and Famous’ type of offer that not many users could ever actually do, but many would want to dream about doing.

User can set ‘On Device’ as the location when looking for something to do. For example, when going on a car ride or connecting via Wi-Fi on an airplane the user might not want to see results nearby. Instead, feasibility search uses a combination of the feasibility search algorithm and user settings to find things to see and do from movie trailers to currently trending web content and videos and from feasibility search partners, to quick games and puzzles, and social networking content.

Computer Implementation

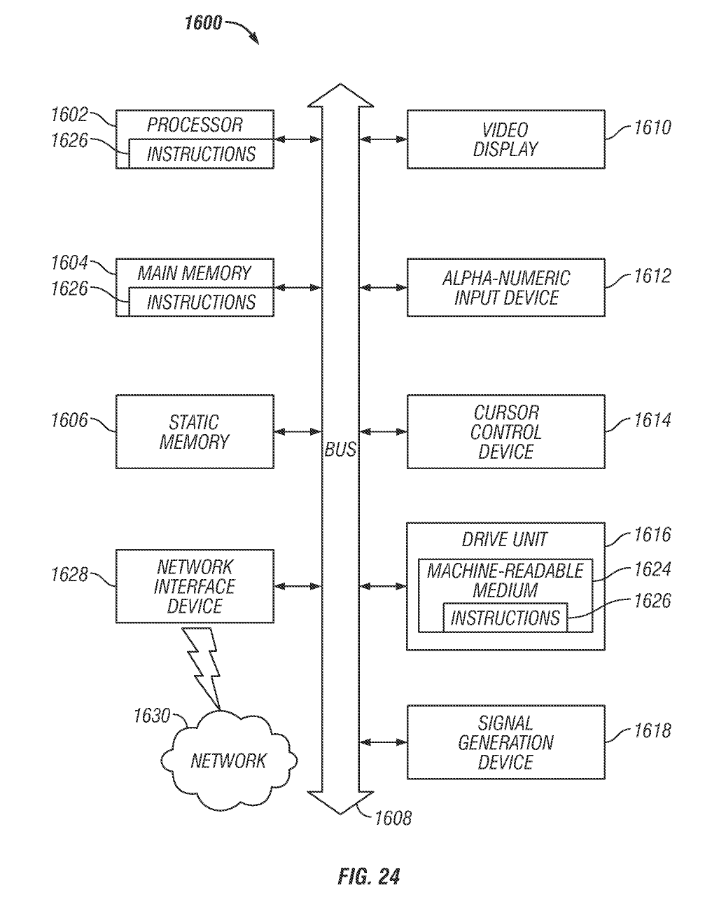

FIG. 24 is a block schematic diagram of a machine in the exemplary form of a computer system 1600 within which a set of instructions for causing the machine to perform any one of the foregoing methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system may 1600 also include an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e. software, 1626 embodying any one, or all, of the methodologies described herein. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities.

Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with complementary metal oxide semiconductor (CMOS), transistor-transistor logic (TTL), very large systems integration (VLSI), or another suitable construction.

Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for effecting a duration-based search, comprising:
a feasibility search engine comprising a module configured for receiving input information comprising:
user information comprising a value for an amount of time that a user has available for any of a plurality of activities or a focused request on a singular activity, a user's current location, and personality information related to said user;
real time transportation information; and
activity related information;
said feasibility search engine configured for combining said input information to identify activities that are available to said user within said amount of time from said user's current location; and
a navigation facility configured:
for receiving user instrumented portions of said user information and for conveying said user instrumented portions of said user information to said feasibility search engine;
for displaying to said user navigation tools to allow user interaction with said feasibility search engine; and
for receiving from said feasibility search engine, and displaying to said user, information comprising activities identified by said feasibility search engine as available to said user within said amount of time from said user's current location or whether or not there is time for one specific activity that the user has specified.

2. The apparatus of claim 1, said navigation facility comprising a feasibility search home screen.

3. The apparatus of claim 1, said navigation facility comprising a feasibility search stick shift slider with which said user sets a range of values for an amount of time that a user has available.

4. The apparatus of claim 1, said navigation facility comprising a tool with which a user can change a starting location for a feasibility search.

5. The apparatus of claim 1, said navigation facility comprising a tool with which a use selects between viewing results without filtering in accordance with said personality information and with filtering by said personality information.

6. The apparatus of claim 1, said navigation facility comprising a tool with which a user changes a date and/or time from which a feasibility search is started.

7. The apparatus of claim 1, said navigation facility comprising a results screen that is configured to present a series of tiles or icons to a user that represent a plurality of categories into which search results broken down;
wherein each tile, when touched by said user, reveals the results in that category.

8. The apparatus of claim 1, said navigation facility comprising a map view screen that displays feasibility search results to the user as icons spread out over a map;
wherein each tile, when touched by said user, brings up more details about an activity or group of activities represented by said tile.

9. The apparatus of claim 1, said navigation facility comprising a screen that shows all results that were determined to be possible by a feasibility search for a selected category, sorted based on a feasibility search algorithm;
wherein activity general information is displayed, including a start time for said activity, an expected finish time for said activity, and a time by which the user would need to leave from a current location to participate in the activity.

10. The apparatus of claim 1, said navigation facility comprising a facility with which said user connects to contacts to get a group to participate in an activity.

11. The apparatus of claim 1, said navigation facility comprising a facility with which said user indicates an interest in an activity.

12. The apparatus of claim 1, said navigation facility comprising a search filtering interface with which a user changes search settings in connection with a plurality of variable attributes;
wherein a plurality of sets of search settings are configurable by said user, each set of settings corresponding to a particular type of activity.

13. The apparatus of claim 1, said navigation facility comprising a set of scrolling words, questions, and/or symbols that are culled from description fields in a feasibility search activities database or other sources, said words and/or symbols comprising collections that change from time to time;
wherein user selection of one or more of said word and/or symbols adjusts said personality information.

14. The apparatus of claim 1, said feasibility search engine comprising:
a module configured for determining a search area: wherein if a starting point is not known, a search starting point algorithm is run; wherein if a starting point is known, a search area radius is calculated by duration (D) divided by 60, multiplied by a average mph per mode of transportation; wherein said calculation returns a circle having a center point comprising a search start location; and wherein any point on a circumference of said circle is equal to a maximum distance the user could travel with the average speed and amount of time given.

15. The apparatus of claim 1, said feasibility search engine comprising:
a module configured for determining a duration-based feasibility test: wherein a distance of an activity from a search start location is calculated; wherein said distance is divided by a rate of speed to determine one way travel time; wherein real-time traffic updates or historical data are used to adjust travel time as appropriate; wherein if a round trip is selected by the user, travel time is multiplied by two; wherein total expected travel time is added to an expected activity duration; wherein any appropriate event buffers comprising average wait time, average parking time, and others are added; wherein a sum of all variables determines a total time for the activity; wherein if said total time is greater than a duration value, said activity is removed from a feasibility search results list.

16. The apparatus of claim 15, wherein a total number of activities on said feasibility results list is used as basis for determining a results pool quality filtering factor; wherein values within a search filtering interface with which a user changes search settings in connection with a plurality of variable attributes are applied to said results as a filtering factor; wherein said results are promoted based on key words from a feasibility search tune up; and wherein said results are returned to said navigation facility for display to said user.

17. A computing implemented method for effecting a duration-based search, comprising:
a processor receiving input information comprising:
user information comprising a value for an amount of time that a user has available for any of a plurality of activities, a user's current location, and personality information related to said user;
real time transportation information; and
activity related information;
said processor combining said input information to identify activities that are available to said user within said amount of time from said user's current location; and
providing a navigation facility configured:
for receiving user instrumented portions of said user information and for conveying said user instrumented portions of said user information to said feasibility search engine;
for displaying to said user navigation tools to allow user interaction with said feasibility search engine; and
for receiving from said feasibility search engine, and displaying to said user, information comprising activities identified by said feasibility search engine as available to said user within said amount of time from said user's current location.

18. A storage medium having stored therein program instructions which, when executed by a processor, executed a method for effecting a duration-based search, comprising:
receiving input information comprising:
user information comprising a value for an amount of time that a user has available for any of a plurality of activities or a specific activity, a user's current location, and personality information related to said user;
real time or historical transportation information; and
activity related information;
combining said input information to identify activities that are available to said user within said amount of time from said user's current location; and
at a navigation facility:
receiving user instrumented portions of said user information and conveying said user instrumented portions of said user information to said feasibility search engine;
displaying to said user navigation tools to allow user interaction with said feasibility search engine; and
receiving from said feasibility search engine, and displaying to said user, information comprising activities identified by said feasibility search engine as available to said user within said amount of time from said user's current location.
